(19) United States
(12) Patent Application Publication
(10) Pub. No.: US 2008/0253899 A1
(43) Pub. Date: Oct. 16, 2008

(54) Brushless motor driving apparatus and fluid pump

(75) Inventor: Shingo Nakanishi, Chita-gun (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/073,124

(22) Filed: Feb. 29, 2008

(30) Foreign Application Priority Data
Apr. 10, 2007 (JP) 2007-102382

(51) Int. Cl. F04B 49/06; H02P 6/18; H02P 6/08

(52) U.S. Cl. 417/44.11; 318/400.34; 318/400.11

(57) ABSTRACT

There is disclosed an apparatus for driving a brushless motor comprising a stator including coils of three phases and a magnet rotor placed in the stator. The apparatus including a controller arranged to rotate the magnet rotor by sequentially switching energization of the coils of the phases, detect a position of the magnet rotor based on induced voltage generated in the coils of the phases, and control the energization of the coils of the phases based on the detected position. When power supply to the control device is interrupted, the controller executes initial setting control for setting the position of the magnet rotor at an initial position allowing next forced drive control to be carried out.

### BACKGROUND OF THE INVENTION

1. Field of the Invention

The present invention relates to a brushless motor driving apparatus which executes induction drive control using a sensorless drive system, and a fluid pump.

2. Description of Related Art

There has heretofore been known a brushless motor using a sensor for detecting a magnetic pole position of a magnet rotor. On the other hand, another brushless motor has also been known which adopts a sensorless drive system which executes “induction drive control”, which is achieved by detecting a voltage signal (induced voltage) induced in each coil of a stator when a magnet rotor is rotated and generating an energization signal for a motor based on a detection signal, instead of using a sensor to detect a magnetic pole position. However, the voltage signal is induced in each coil only while the magnet rotor is rotating. At the stop of the motor, no voltage is induced in each coil. Thus, positional information of the magnet rotor is not obtained. At the time of activation of the motor, the magnet rotor has to be forcibly rotated, that is, to be forcibly driven (“forced drive control”). At that time, it is necessary to perform the initial setting for setting an initial position of the magnet rotor to a predetermined position in order to prevent reverse rotation of the magnet rotor or other disadvantages in the “forced drive control”. This would need much time and hence the brushless motor could not be activated immediately.

JP2000-60070A discloses a brushless motor provided with a permanent magnet for restricting a stop position so that a magnet rotor is stopped at a specified stop position by a magnetic force of the permanent magnet. This brushless motor could be activated in such a manner that the initial position of the magnet rotor is set to the predetermined position at the beginning of activation even though a hall element or the like is not provided for detecting the position of the magnet rotor. It is conceivable to use such brushless motor for a fuel pump in a vehicle engine.

However, the brushless motor disclosed in JP'070A has to be arranged to cancel the magnetic force of the permanent magnet while the motor is rotated. Accordingly, a demagnetizing coil needs to be additionally installed and constantly energized during rotation of the brushless motor. Consequently, power consumption of such brushless motor would increase, causing a decrease in motor efficiency. In the case where this type of brushless motor is used in a fuel pump in a vehicle engine, fuel efficiency may deteriorate. At engine start, the fuel pump has to be immediately activated to quickly supply fuel to the engine. However, the brushless motor takes much time as a means for recognizing the position of the magnet rotor at the beginning of activation of the fuel pump. The brushless motor is therefore inadequate for such means.

### BRIEF SUMMARY OF THE INVENTION

The present invention has been made in view of the above circumstances and has an object to provide a brushless motor driving apparatus capable of achieving a shorter activation time and reduced power consumption, and preventing a decrease in motor efficiency. Another object of the present invention is to provide a fuel pump capable of rapidly increasing fluid pressure at engine start.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a brushless motor driving apparatus for driving a brushless motor comprising a stator including coils of a plurality of phases and a magnet rotor placed in the stator, the apparatus including a control device arranged to rotate the magnet rotor by sequentially switching energization of the coils of the phases, detect a position of the magnet rotor based on induced voltage generated in the coils of the phases, and control the energization of the coils of the phases based on the detected position, wherein, when power supply to the control device is interrupted, the control device executes initial setting control for setting the position of the magnet rotor at an initial position allowing next forced drive control to be carried out.

According to another aspect, the invention provides a fluid pump provided in association with an engine, the pump comprising: a brushless motor as a drive source, the brushless motor comprising a stator including coils of a plurality of phases and a magnet rotor placed in the stator; a control device arranged to rotate the magnet rotor by sequentially switching energization of the coils of the phases, detect a position of the magnet rotor based on induced voltage generated in the coils of the phases, and control the energization of the coils of the phases based on the detected position; and a pump section for increasing pressure of a fluid based on torque of the magnet rotor, wherein the control device executes initial setting control at the stop of the engine for setting the position of the magnet rotor at an initial position allowing next forced drive control to be carried out and the control device executes the forced drive control at the start of the engine without carrying out the initial setting control.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a fuel tank mounted in association with an engine in a vehicle;

FIG. 2 is an electric circuit diagram showing configurations of a brushless motor and a controller for a fuel pump, and others;

FIG. 3 is a conceptual diagram showing a control logic;

FIG. 4 is a time chart showing energization timing of each phase in an induction drive mode and variations in induced voltage in each phase;

FIG. 5 is a time chart showing variations in terminal voltage in the coils of the phases;

FIG. 6 is a time chart showing variations in energization duty value to each coil of the phases;

FIGS. 7A to 7F are conceptual diagrams showing a positional relationship between a stator and a magnet rotor in a state where a motor is stopped; and

FIG. 8 is a conceptual diagram showing a change of energized phases and a change in the positional relationship between the stator and the magnet rotor.

### DETAILED DESCRIPTION OF THE PREFERRED EMBODIMENTS

A detailed description of a preferred embodiment of a brushless motor driving apparatus and a fluid pump embodying the present invention will now be given referring to the accompanying drawings.

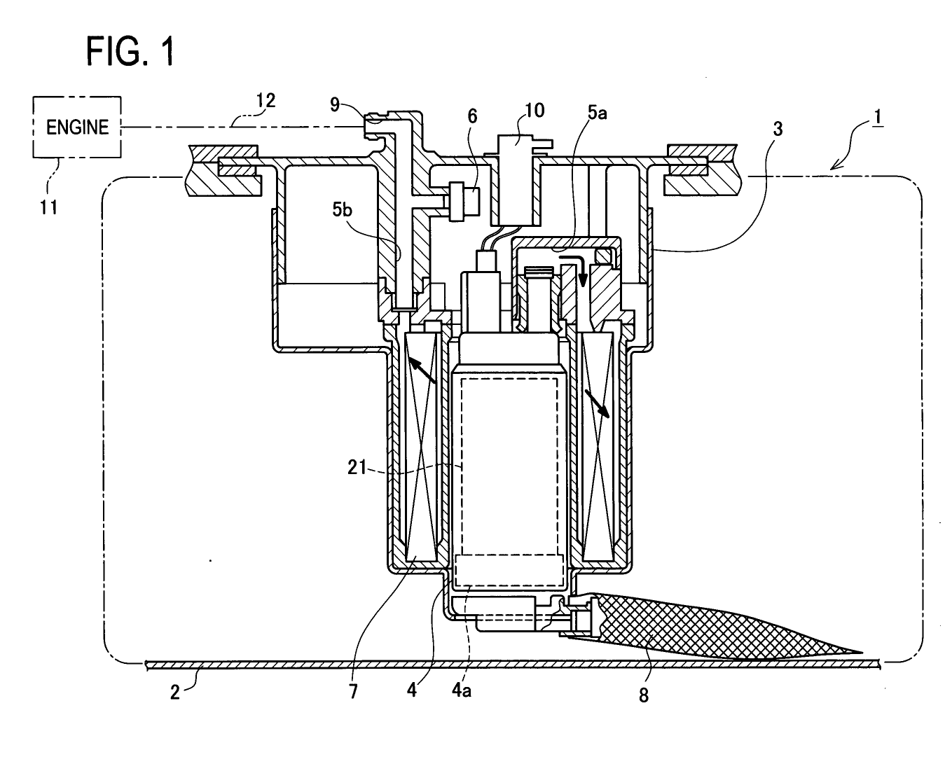

The following explanation will be given to embodiments of an electric fuel pump in an engine and a brushless motor driving apparatus to be used in the fuel pump. FIG. 1 is a sectional view of a fuel tank 1 to be mounted in association with an engine 11 in a vehicle. In the fuel tank 1, a high-pressure filter cover 3 is formed separately from a tank body 2. This high-pressure filter cover 3 is provided with an electric fuel pump (hereinafter, simply a “fuel pump”) 4, fuel passages 5a and 5b, a pressure regulator 6, and a high-pressure fuel filter 7. A fuel filter 8 is attached to a suction port of the fuel pump 4. When the fuel pump 4 is operated, the fuel stored in the tank body 2 is sucked into the fuel pump 4 through the fuel filter 8. Then the fuel passes through the high-pressure fuel filter 7 via the fuel passage 5a and further passes through the fuel passage 5b. The fuel is controlled in pressure by the pressure regulator 6 and subsequently discharged through an outlet port 9. The discharged fuel is supplied to an engine 11 through a fuel line 12. In an uppermost part of the high-pressure filter cover 3, a controller 10 is placed for controlling the fuel pump 4 electrically connected to the controller 10. In the present embodiment, the controller 10 corresponds to a control device of the present invention. In the present embodiment, the fuel pump 4 includes a brushless motor 21 as a drive source in order to achieve a long life and a pump section 4a for increasing the pressure of fuel based on output power of the motor 21. The pump section 4a is provided with a rotation member (not shown) such as a fin which is rotated by torque of a magnet rotor 24 which will be mentioned later.

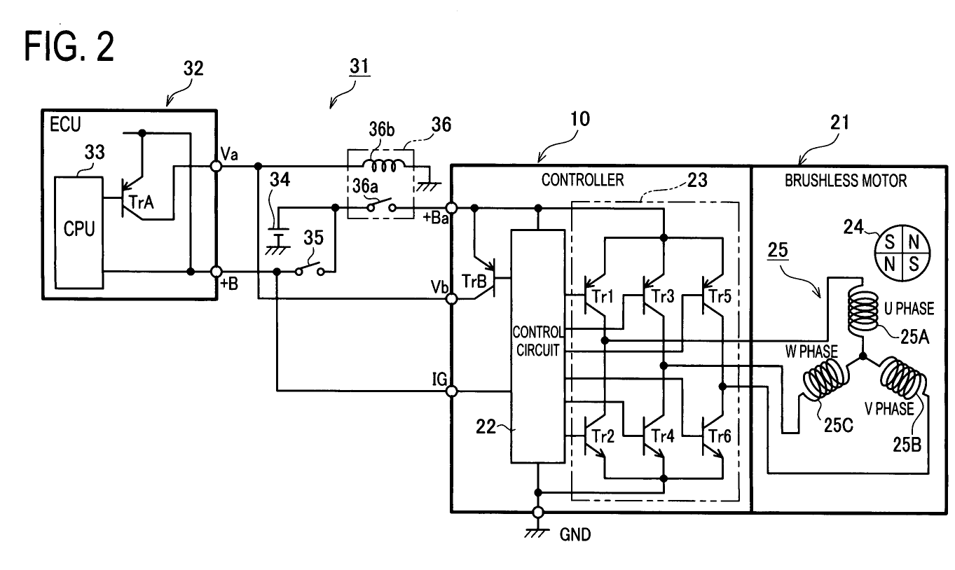

FIG. 2 is an electric circuit diagram showing configurations of the brushless motor 21 used in the fuel pump 4 and the controller 10 thereof, and others. The controller 10 includes a control circuit 22, a drive circuit 23, and a second power transistor TrB. In the present embodiment, the brushless motor 21 is a three-phase motor. The drive circuit 23 is a circuit adopting a three-phase full-wave drive system. The brushless motor 21 is configured to detect the position of the magnet rotor 24 (a rotor position) by using no hall element but utilizing induced voltage (generated voltage) produced in coils 25A, 25B, and 25C of a plurality of phases (U phase, V phase, and W phase) of the stator constituting the brushless motor 21. Specifically, the brushless motor 21 is arranged to detect the rotor position based on the induced voltage generated by the rotation of the magnet rotor 24 that is also a movable member of the fuel pump 4 and determine the coils 25A to 25C of the three phases to be energized. However, no induced voltage is generated at startup, the magnet rotor 24 is “forcibly driven” to rotate. After the induced voltage is generated in the forced drive control (mode), the forced drive control (mode) is switched to the “induction drive” control (mode) which is carried out by detecting the induced voltage.

As shown in FIG. 2, the drive circuit 23 is constituted by first, third, and fifth transistors Tr1, Tr3, and Tr5 of PNP type and second, fourth, and sixth transistors Tr2, Tr4, and Tr6 of NPN type, all the transistors serving as switching elements. Those first to sixth transistors Tr1 to Tr6 are connected in three-phase bridge configuration. The first, third, and fifth transistors Tr1, Tr3, and Tr5 have emitters which are connected respectively to a power supply terminal (+Ba) of the controller 10, while the second, fourth, and sixth transistors Tr2, Tr4, and Tr6 have emitters which are grounded respectively. The three-phase brushless motor 21 includes the magnet rotor 24, and the stator 25 including the coils 25A, 25B, and 25C forming the U phase, the V phase, and the W phase respectively. The coils 25A, 25B, and 25C of the U, V, and W phases have, at one ends, a common terminal to which all the phase coils are connected. At the other ends, the coil 25A has a terminal connected to a common connection point of the first and second transistors Tr1 and Tr2, the coil 25C has a terminal connected to a common connection point of the third and fourth transistors Tr3 and Tr4, and the coil 25B has a terminal connected to a common connection point of the fifth and sixth transistors Tr5 and Tr6. Each base of the transistors Tr1 to Tr6 is connected to the control circuit 22. One terminal of the control circuit 22 is connected to the power supply terminal (+Ba) of the controller 10 and the other terminal thereof is grounded. In the present embodiment, the control circuit 22 is provided as a custom IC. The second power supply transistor TrB is constituted of a PNP-type transistor that has an emitter connected to the power supply terminal (+Ba) of the controller 10, a collector connected to a terminal (Vb) of the controller 10, and a base connected to the control circuit 22.

As shown in FIG. 2, the controller 20 is connected to an electronic control unit (ECU) 32 via a power supply circuit 31. The power supply circuit 31 is a circuit for supplying electric power to the ECU 32 and the controller 10. The ECU 32 is a device that mainly controls the engine 11. The ECU 32 includes a central processing unit (CPU) 33 and a first power supply transistor TrA. The CPU 33 is connected to a power supply terminal (+B) of the ECU 32. The first power supply transistor TrA is constituted of a PNP-type transistor that has an emitter connected to the power supply terminal (+B) of the ECU 32, a collector connected to a terminal (Va) of the ECU 32, and a base connected to the CPU 33.

The power supply circuit 31 includes a battery 34, an ignition switch (IG/SW) 35, and a relay 36. A switch 36a of the relay 36 is connected at one end to the power supply terminal (+Ba) of the controller 10 and at the other end to the battery 34. The ignition switch 35 is connected at one end to the battery 34 and at the other end to the power supply terminal (+B) of the ECU 32. A coil 36b of the relay 36 is connected at one end to the terminal (Va) of the ECU 32 and grounded at the other end. The terminal (Vb) of the controller 10 is connected to the terminal (Va) of the ECU 32. One end of the ignition switch 35 is connected to the control circuit 22 via the IG terminal (IG) of the controller 10.

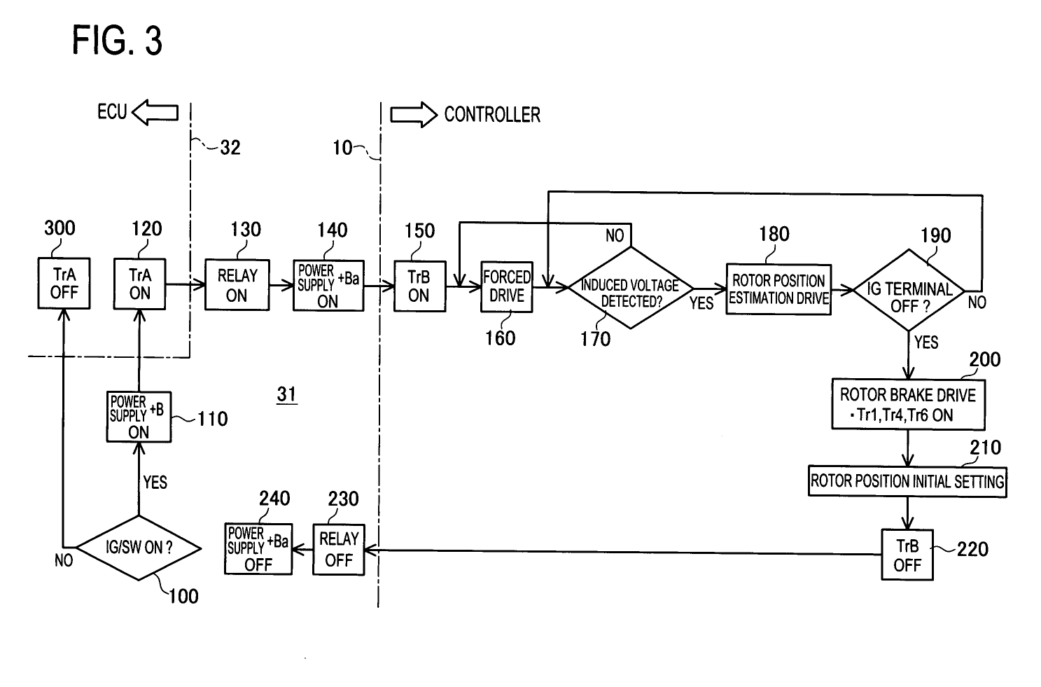

An explanation will be given to the control logic which is executed by the ECU 32 and the controller 10, referring to FIG. 3 showing the conceptual diagram.

At step 100, initially, when the ignition switch (IG/SW) of the power supply circuit 31 is not turned “ON”, the CPU 33 turns the first power supply transistor TrA “OFF” at step 300.

At step 100, on the other hand, when the ignition switch (IG/SW) 35 is turned “ON”, the power supply terminal (+B) of the ECU 32 is turned “ON” at step 110. Thus, the first power supply transistor TrA of the ECU 32 is turned “ON” at step 120, and the relay 36 of the power supply circuit 31 is turned “ON” at step 130, turning the power supply terminal (+Ba) of the controller 10 “ON” at step 140.

At that time, the second power supply transistor TrB of the controller 10 is turned “ON” at step 150 and then the control circuit 22 “forcibly drives” the magnet rotor 24 at step 160. Specifically, a specific one of the coils 25A, 25B, and 25C of the U, V, and W phases is energized irrespective of the position of the magnet rotor 24 (the rotor position).

At step 170, the control circuit 22 detects the induced voltage. If no induced voltage is detected, the control circuit 22 “forcibly drives” the magnet rotor 24 again at step 160. If the induced voltage is detected, the control circuit 22 drives the rotor 24 by estimating the rotor position at step 180. Subsequently, the control circuit 22 determines at step 190 whether or not the IG terminal (IG) of the controller 10 is “OFF”. In other words, it is determined whether or not the ignition switch (IG/SW) 35 is turned “OFF”. Specifically, if the IG terminal (IG) remains “ON”, the control circuit 22 returns to step 170 and implements the processing in steps 170 to 190 again. Thus, the control circuit 22 repeats steps 170 to 190 to execute the “induction drive control”. This “induction drive control” will be explained in detail later.

If the IG terminal (IG) is determined to be “OFF” at step 190, on the other hand, the control circuit 22 turns the first, fourth, and sixth transistors Tr1, Tr4, and Tr6 “ON” in order to perform rotor brake drive control. Specifically, the control circuit 22 executes the “brake drive control”. This gives a braking force to the magnet rotor 24, reducing the speed of rotation of the rotor 24.

At step 210, subsequently, the control circuit 22 performs rotor position initial setting. Specifically, the control circuit 22 executes the “initial setting control”, the details of which will be explained later. The control circuit 22 turns the second power supply transistor TrB “OFF” at step 220. Accordingly, at step 230, the relay 36 of the power supply circuit 31 is turned “OFF” and the power supply terminal (+Ba) of the controller 10 is turned “OFF”. That is, when the ignition switch 35 is turned OFF to stop the engine 11, the control circuit 22 waits until the rotor position initial setting is completed and then stops power supply to the controller 10.

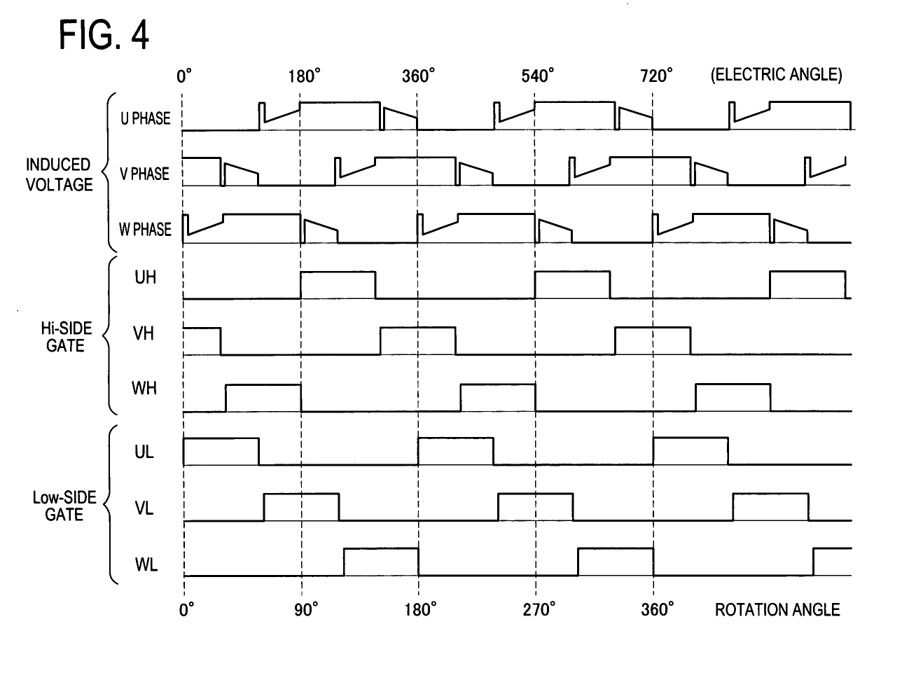

Here, the aforementioned “induction drive control” is explained below. FIG. 4 is a time chart showing the timing of energization of each phase executed by the control circuit 22 during the induction drive control and variations in induced voltage in each phase. The control circuit 22 controls energization of each base (gate) of the transistors Tr1 to Tr6 of the drive circuit 23 to control energization of the coils 25A to 25C of the U to W phases. In FIG. 4, the words “UH, VH, WH” indicate a Hi-side gate for setting the U, V, and W phases at a high level and the words “UL, VL, WL” indicate a Low-side gate for setting the U, V, and W phases at a low level. As shown in FIG. 4, when energization of the Hi-side gate and the Low-side gate is controlled, the coils 25A to 25C of the U to W phases are energized selectively, generating induced voltage in each coil.

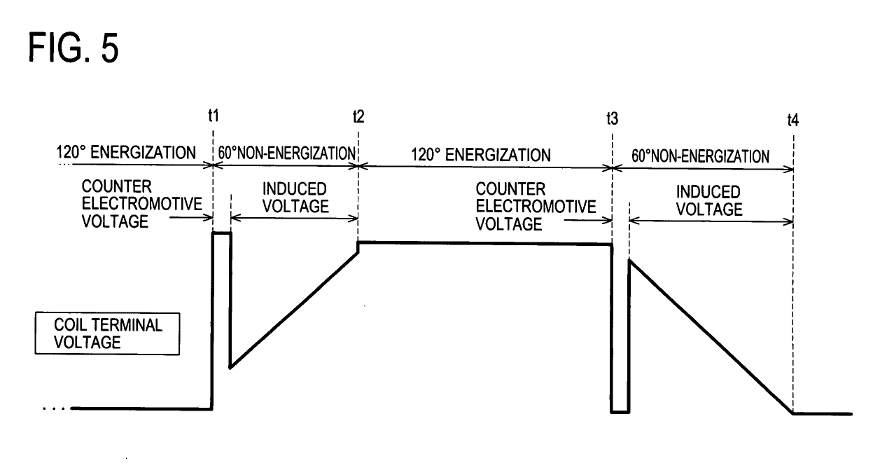

FIG. 5 is a time chart showing variations in terminal voltage of each coil 25A, 25B, 25C of each phase (U phase, V phase, and W phase). As is found from this chart, each coil 25A, 25B, 25C is subjected to “120° energization” and “60° non-energization” alternately. In FIG. 5, when the coil is switched to a non-energized state at time t1, a positive counter electromotive force is first generated as pulse-shaped voltage and subsequently induced voltage increases. During a period from switching to energization at time t2 up to switching to non-energization at time t3, the voltage stays positive at a constant level. When the coil is switched to a non-energized state at time t3, a negative counter electromotive force is generated as pulse-shaped voltage and subsequently inducted voltage decreases. When the coil is switched to the energized state at time t4, the voltage stays negative at a constant level. The control circuit 22 detects the rotor position by utilizing the induced voltage generated following the counter electromotive voltage. The control circuit 22 controls energization of the coils 25A to 25C of the U, V, and W phases based on the rotor position detected as above. Specifically, the control circuit 22 causes the magnet rotor 24 to rotate by sequentially switching energization of the coils 25A to 25C of the U to W phases of the stator 25. The control circuit 22 further detects the rotor position based on the induced voltage generated in each coil 25A, 25B, 25C of each U, V, W phase as above to perform the “induction drive control” for controlling the energization of the coils 25A to 25C of the U to W phases based on the detected rotor position.

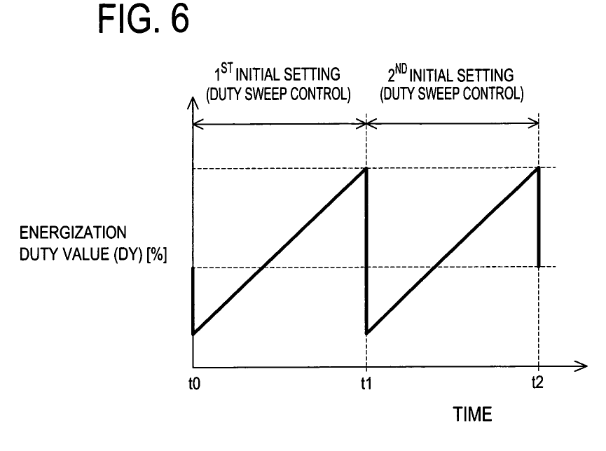

An explanation will be given below to the aforementioned “rotor position initial setting (initial setting control)”. The control circuit 22 performs the initial setting twice at step 210 in FIG. 3. In other words, at the first initial setting (duty sweep control), the control circuit 22 gradually changes an energization duty value DY with respect to each coil 25A, 25B, 25C of the U to W phases. In the present embodiment, as shown from time t0 to time t1 in FIG. 6, a value of the energization duty value DY is gradually increased from a short time (a small energization ratio) to a long time (a large energization ratio). Subsequently, in the second initial setting (duty sweep control), the control circuit 22 gradually changes the energization duty value DY to each coil 25A, 25B, 25C of the U to W phases again in the same manner as in the first time. In the present embodiment, as shown by times t1 to t2 in FIG. 6, a value of the energization duty value DY is gradually increased from a short time (a small energization ratio) to a long time (a large energization ratio) again.

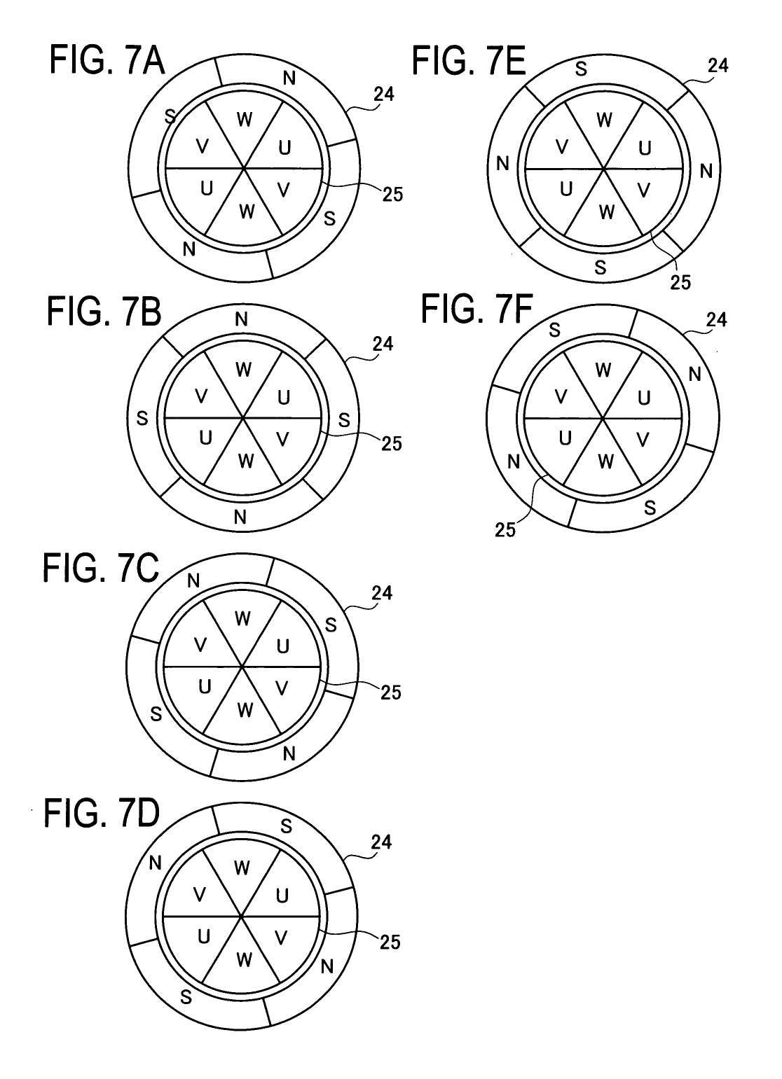

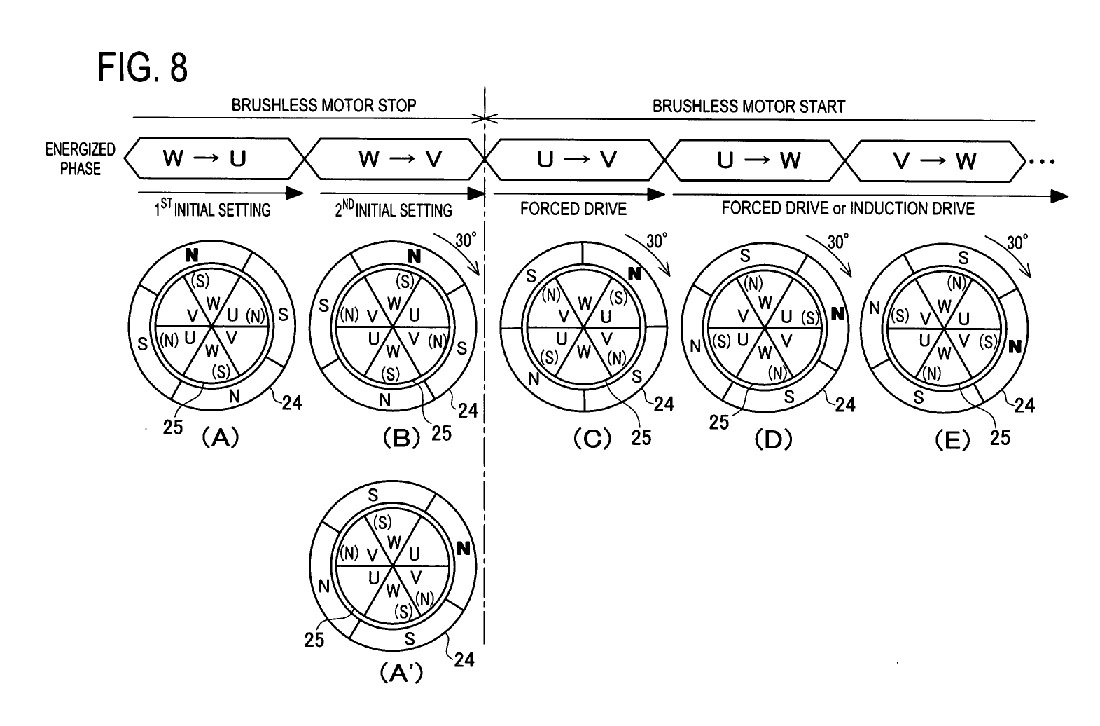

Here, an explanation is given to the positional relationship between the magnet rotor 24 and the stator 25 including the U, V, W phases in each of the first initial setting (duty sweep control) and the second initial setting (duty sweep control). FIGS. 7A to 7F are conceptual diagrams showing conceivable positional relationships between the stator 25 and the magnet rotor 24 during a motor stop state. FIG. 8 is a conceptual diagram showing a change of energized phases between the first initial setting and the second initial setting and a change in the positional relationship between the stator 25 and the magnet rotor 24. When the first initial setting is started from the motor stop state shown in FIGS. 7A to 7F, the magnet rotor 24 begins to slowly move into a state (A) or (A′) in FIG. 8. Subsequently, the second initial setting is performed, so that the magnet rotor 24 is additionally rotated 30° or 60° into a state (B) in FIG. 8. At the stop of the engine 11, i.e., at the stop of the fuel pump 4 and hence at the stop of the brushless motor 21, the stator 25 and the magnet rotor 24 are stopped in the state (B) in FIG. 8. The position of the magnet rotor 24 in (B) of FIG. 8 is an “initial position” allowing the next “forced drive control” to be carried out. The magnet rotor 24 is set to the “initial position” by the two initial setting operations. Accordingly, at the start of the brushless motor 21, the energization is conducted from the U phase to the V phase (U→V) in the state (B) in FIG. 8 (the initial position), thus easily carrying out the “forced drive control”, allowing the magnet rotor 24 to further rotate 30° into a state (C) in FIG. 8. Subsequently, the energization is conducted from the U phase to the W phase (U→W) and from the V phase to the W phase (V→W) in turn, thereby carrying out the “forced drive” or the “induction drive”. This causes the magnet rotor 24 to further rotate 30° each into states (D) and (E) in FIG. 8 sequentially.

According to the driving apparatus of the brushless motor 21 in the present embodiment explained above, the magnet rotor 24 is stopped at the initial setting position in response to the turn-off of the ignition switch 35. In the present embodiment, when the ignition switch 35 is turned OFF, the controller 10 executes the “initial setting control” on each coil 25A, 25B, 25C of the U to W phases, so that the position of the magnet rotor 24 is initially set at the initial position allowing the next “forced drive control” to be conducted and then the magnet rotor 24 is stopped. To start the brushless motor 21 next, therefore, the magnet rotor 24 begins to rotate immediately by the forced drive control. This makes it possible to shorten the activation time of the brushless motor 21, thereby reducing power consumption of the motor 21. Further, different from the prior art, there is no need for providing a demagnetizing coil that has to be constantly energized during motor operation to cancel a magnetic force of a permanent magnet for restricting a stop position. Thus, a decrease in motor efficiency can be prevented.

In the present embodiment, the controller 10 executes the “brake drive control” for stopping the rotation of the magnet rotor 24 prior to the “initial setting control”. The rotation of the magnet rotor 24 can thus be reduced in speed promptly before the “initial setting control”. At the stop of the brushless motor 21, accordingly, the initial setting control can be terminated at once.

In the present embodiment, the stator 25 includes the coils 25A to 25C of three phases, and those coils 25A to 25C are excited by the three-phase full-wave drive system. The magnet rotor 24 can be placed in such a positional relationship with the stator 25 as to allow the forced drive to be efficiently conducted. Therefore, the three-phase brushless motor 21 in the present embodiment can efficiently carry out the “force drive control”.

According to the fuel pump 4 of the present embodiment, the magnet rotor 24 is stopped in response to the turn-off of the ignition switch 35, thereby stopping the fuel pump 4. In the present embodiment, at the stop of the engine 11, the controller 10 executes the “initial setting control” to initially set the position of the magnet rotor 24 at the “initial position” allowing the next “force drive control” to be carried out. At the start of the engine 11, furthermore, the controller 10 executes the “forced drive control” without executing the initial setting control. Accordingly, at the start of the engine 11, the magnet rotor 24 begins to rotate immediately by the “forced drive control”, promptly activating the fuel pump 4. Consequently, the fuel can be increased in pressure quickly at the start of the engine 11 and thus can be supplied to the engine 11 rapidly. In this regard, the engine 11 can have enhanced startability, a reduced start time, and improved fuel consumption.

The present invention is not limited to the aforementioned embodiment and may be embodied in other specific forms without departing from the essential characteristics thereof.

The fluid pump of the invention is embodied as the fuel pump 4 in the above embodiment, but it may be embodied as an electric water pump.

The driving apparatus of the invention is embodied as the three-phase brushless motor 21, but it may be embodied appropriately as another brushless motor having the number of phases other than three.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A brushless motor driving apparatus for driving a brushless motor comprising a stator including coils of a plurality of phases and a magnet rotor placed in the stator, the apparatus including a control device arranged to rotate the magnet rotor by sequentially switching energization of the coils of the phases, detect a position of the magnet rotor based on induced voltage generated in the coils of the phases, and control the energization of the coils of the phases based on the detected position,
wherein, when power supply to the control device is interrupted, the control device executes initial setting control for setting the position of the magnet rotor at an initial position allowing next forced drive control to be carried out.

2. The brushless motor driving apparatus according to claim 1, wherein the control device executes brake drive control for stopping rotation of the magnet rotor prior to the initial setting control.

3. The brushless motor driving apparatus according to claim 1, wherein the stator includes coils of three phases and the coils of the phases are excited by a three-phase full-wave drive system.

4. The brushless motor driving apparatus according to claim 2, wherein the stator includes coils of three phases and the coils of the phases are excited by a three-phase full-wave drive system.

5. The brushless motor driving apparatus according to claim 1, wherein the control device performs the initial setting control twice and executes duty sweep control for gradually changing an energization duty value to each coil of the phases in each of the two initial setting control operations.

6. The brushless motor driving apparatus according to claim 2, wherein the control device performs the initial setting control twice and executes duty sweep control for gradually changing an energization duty value to each coil of the phases in each of the two initial setting control operations.

7. The brushless motor driving apparatus according to claim 3, wherein the control device performs the initial setting control twice and executes duty sweep control for gradually changing an energization duty value to each coil of the phases in each of the two initial setting control operations.

8. The brushless motor driving apparatus according to claim 4, wherein the control device performs the initial setting control twice and executes duty sweep control for gradually changing an energization duty value to each coil of the phases in each of the two initial setting control operations.

9. A fluid pump provided in association with an engine, the pump comprising: a brushless motor as a drive source, the brushless motor comprising a stator including coils of a plurality of phases and a magnet rotor placed in the stator; a control device arranged to rotate the magnet rotor by sequentially switching energization of the coils of the phases, detect a position of the magnet rotor based on induced voltage generated in the coils of the phases, and control the energization of the coils of the phases based on the detected position; and a pump section for increasing pressure of a fluid based on torque of the magnet rotor,
wherein the control device executes initial setting control at the stop of the engine for setting the position of the magnet rotor at an initial position allowing next forced drive control to be carried out and the control device executes the forced drive control at the start of the engine without carrying out the initial setting control.

10. The fluid pump according to claim 9, wherein
the control device executes brake drive control for stopping the rotation of the magnet rotor prior to the initial setting control.

11. The fluid pump according to claim 9, wherein
the stator includes coils of three phases and the coils of the phases are excited out by a three-phase full-wave drive system.

12. The fluid pump according to claim 10, wherein
the stator includes coils of three phases and the coils of the phases are excited out by a three-phase full-wave drive system.

13. The fluid pump according to claim 9, which is to be used as one of an electric fuel pump for the engine.

14. The fluid pump according to claim 10, which is to be used as one of an electric fuel pump for the engine.

15. The fluid pump according to claim 11, which is to be used as one of an electric fuel pump for the engine.

16. The fluid pump according to claim 12, which is to be used as one of an electric fuel pump for the engine.

17. The fluid pump according to claim 9, wherein
the control device performs the initial setting control twice and executes duty sweep control for gradually changing an energization duty value to each coil of the phases in each of the two initial setting control operations.

18. The fluid pump according to claim 10, wherein
the control device performs the initial setting control twice and executes duty sweep control for gradually changing an energization duty value to each coil of the phases in each of the two initial setting control operations.

19. The fluid pump according to claim 11, wherein
the control device performs the initial setting control twice and executes duty sweep control for gradually changing an energization duty value to each coil of the phases in each of the two initial setting control operations.

20. The fluid pump according to claim 12, wherein
the control device performs the initial setting control twice and executes duty sweep control for gradually changing an energization duty value to each coil of the phases in each of the two initial setting control operations.
